(19) United States
(12) Patent Application Publication
(10) Pub. No.: US 2002/0159713 A1
(43) Pub. Date: Oct. 31, 2002

(54) Connector for a fiber optic cable

(76) Inventor: Yu-Feng Cheng, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/908,646

(22) Filed: Jul. 20, 2001

(30) Foreign Application Priority Data
Apr. 30, 2001 (TW) 090206931

(51) Int. Cl. G02B 6/38

(52) U.S. Cl. 385/70

(57) ABSTRACT

A connector for a fiber optic cable has at least one clamp sheet fitted in a corresponding at least one slit defined therethrough. The clamp sheet is particularly defined with an H-shaped opening having upper and lower edges respectively formed with two insertion pieces. Whereby when upper and lower ends of the clamp sheet are pressed inwardly, the insertion pieces of the clamp sheet respectively pierce an outer cover of the fiber optic cable fed through the opening of the clamp sheet, such that deviations including the rotational movement of the cable are effectively avoided, and the fiber optic cable is accurately positioned in the connector and securely connected with respect to the connector.

### BACKGROUND OF THE INVENTION

1. Field of the Invention

The present invention relates to a fiber optic connector, which has at least one clamp sheet particularly with an H-shaped opening defined therein and two insertion pieces respectively formed at upper and lower edges of the opening.

2. Description of Related Art

A fiber optic connector is used to join one fiber optic cable together with another one. Because the signal is transmitted via the fiber optic filament enclosed in an outer cover and an inner cover of the cable, the alignment of the filaments between two individual cables is a decisive factor of the quality of the signal transmission.

A conventional fiber optic connector normally comprises an integrally formed body with multiple transversal slits defined therethrough, and multiple clamps respectively fitted in the corresponding slits. Each one of the clamps is defined with one opening in a circular shape corresponding to the cross sectional shape of the cable. When upper and lower ends of the clamps are respectively pressed inwardly, a cable inserted into the body of the connector and fed through the openings of the clamps is tightly clamped by the clamps and securely connected with the connector.

However, the aforesaid conventional connector still has a defect that the cable fed through the circular openings of the clamps may be forced to turn in the circular openings of the clamps, thereby resulting in a deviation of the filament of the cable, which means a degradation of the signal transmission.

Therefore, it is an objective of the invention to provide an improved connector for a fiber optic cable to mitigate and/or obviate the aforementioned problems.

### SUMMARY OF THE INVENTION

The object of the present invention is to provide a fiber optic connector, which has at least one clamp sheet fitted in at least one corresponding slit defined through the connector. The clamp sheet is therein particularly defined with an H-shaped opening with two insertion pieces formed at upper and lower edges of the opening. Whereby a cable inserted in the connector is tightly clamped by the clamp sheet, when the insertion pieces respectively pierce an outer cover of the cable under an inward pressing force applying at upper and lower ends of the clamp sheet. The cable is thus securely connected in the connector and prevented from a rotation with respect to the connector.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a connector in accordance with the invention;

FIG. 2 is an exploded perspective view of the first embodiment of the connector in accordance with the invention;

FIG. 3 is a cross sectional view of the first embodiment of the connector, showing the state of a clamp sheet fitted in the connector when the fiber optic cable is not clamped by the clamp sheet;

FIG. 4 is a cross sectional view of the first embodiment of the connector, showing the fiber optic cable being tightly clamped by the clamp sheet;

FIG. 5 is a perspective view of a second embodiment of the clamp sheet of the connector in accordance with the invention;

FIG. 6 is a perspective view of a third embodiment of the clamp sheet of the connector in accordance with the invention;

FIG. 7 is a perspective view of a fourth embodiment of the clamp sheet of the connector in accordance with the invention;

FIG. 8 is a perspective view of a fifth embodiment of the clamp sheet of the connector in accordance with the invention;

FIG. 9 is a perspective view of a sixth embodiment of the clamp sheet of the connector in accordance with the invention;

FIG. 10 is a perspective view of a seventh embodiment of the clamp sheet of the connector in accordance with the invention; and

FIG. 11 is a perspective view of an eighth embodiment of the clamp sheet of the connector in accordance with the invention.

### DETAILED DESCRIPTION OF THE PREFERRED EMBODIMENT

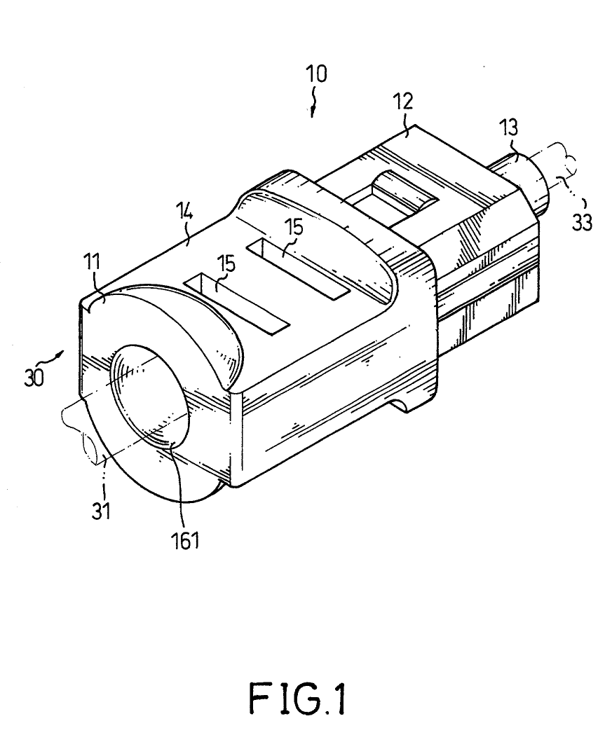

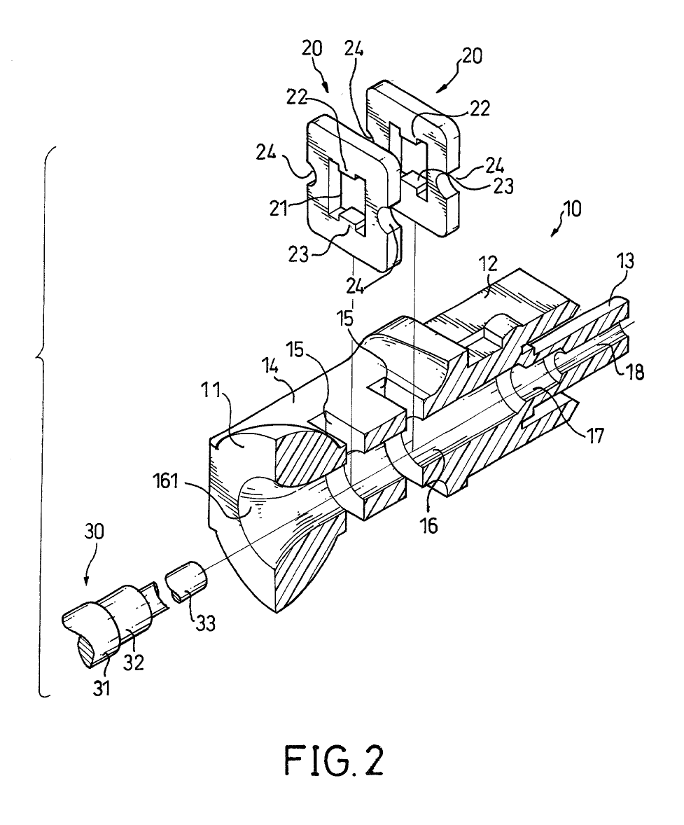

As shown in FIGS. 1 and 2, a fiber optic connector (10) in accordance with the present invention comprises a holding portion (11), a waist (12) and a head (13). The holding portion (11) has upper and lower flats (14) formed thereon, and two radially extending slits (15) respectively defined therethrough. A longitudinal stepped hole including first, second and third sections (16, 17 and 18) is defined in connector (10).

Each one of the slits (15) are respectively fitted with one clamp sheet (20), which is particularly formed in a rectangular shape according to the slit (15). The clamp sheet (20) is therein specially defined with an H-shaped opening (21) having upper and lower edges respectively formed with two insertion pieces (22, 23) extending therefrom along a same extending direction of the clamp sheet (20). The clamp sheet (20) is further defined with two arched concavities (24) respectively at two opposite sides thereof.

As seen in FIG. 2, an end portion of a fiber optic cable (30) has its enclosures partially peeled off, and has a first section with both an outer cover (31) and an inner cover (32) enclosed therearound, a second section with only the inner cover (32) enclosed therearound, and a third section has its filament (33) completely exposed. Lengths of the second and third sections are respectively corresponding to the second and the third sections (17, 18) of the stepped hole in the connector (10).

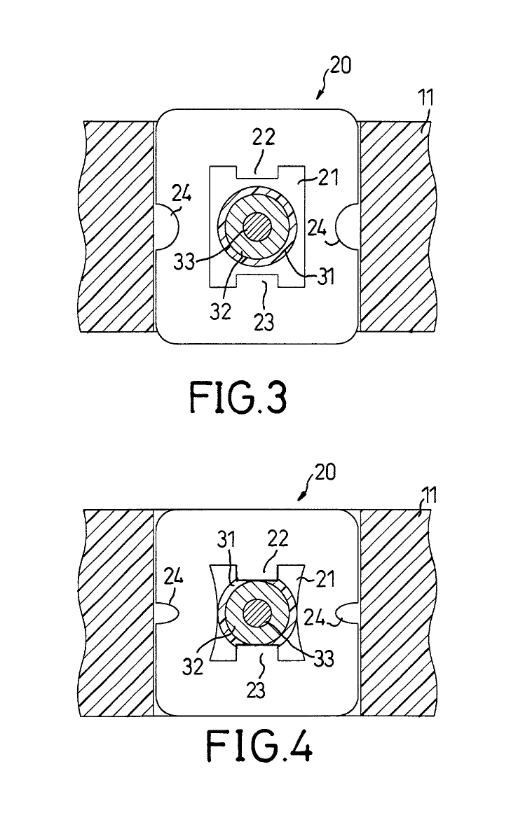

With reference to FIGS. 3 and 4, when the fiber optic cable (30) is inserted from a flared opening (161) into the stepped hole of the connector (10), the first, second and third sections of the end portion of the cable (30) are respectively fitted in the corresponding first, second and third sections (16, 17, 18) of the connector (10). The first section of end portion of the cable (30) is fed through the openings (21) of the clamps (20), which are respectively fitted in the corresponding slits (15). Then upper and lower ends of clamp sheets (20) are respectively pressed inwardly so as to force the insertion pieces (22, 23) to respectively pierce the outer cover (3 1) of the cable (30). Therefore, the cable (30) is tightly clamped by the rectangular clamp sheets (20) respectively fitted in the slits (15) of the connector (10).

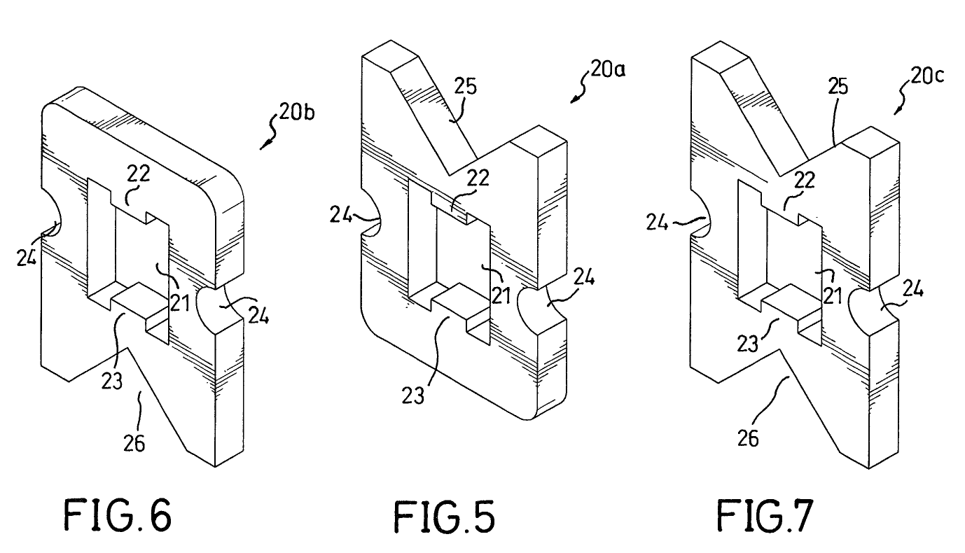

In FIG. 5, a second practicable embodiment of a clamp sheet (20a) is shown. The clamp sheet (20a) is defined with a V-groove (25) in the upper end thereof.

FIG. 6 shows a third embodiment of a clamp sheet (20b) having an inverted V-groove (26) defined in the lower end thereof.

FIG. 7 shows a fourth embodiment of a clamp sheet (20c) having a V-shaped groove (25′) and an inverted V-shaped groove (26′) respectively defined in the upper and lower ends thereof.

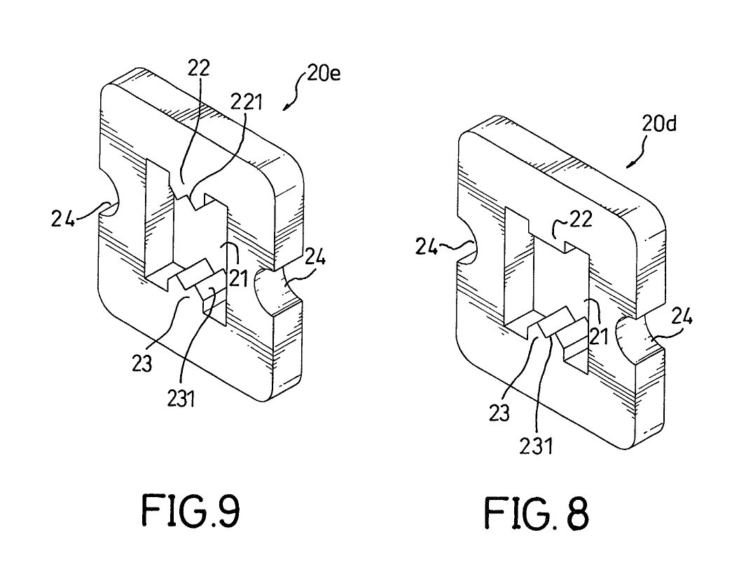

As shown in FIG. 8, a fifth embodiment of a clamp sheet (20d) has the insertion piece (23) particularly formed with a toothed edge (231) to increase its friction force against the rotation of the cable (30).

FIG. 9 shows a sixth embodiment of a clamp sheet (20e) has the two insertion pieces (22, 23) respectively formed with toothed edges (221, 231) so as to increase their friction force against the rotation of the cable (30).

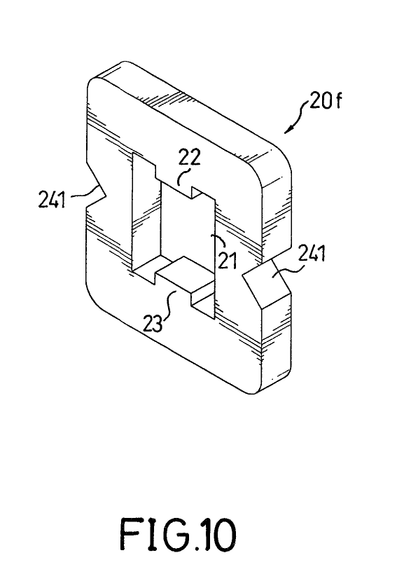

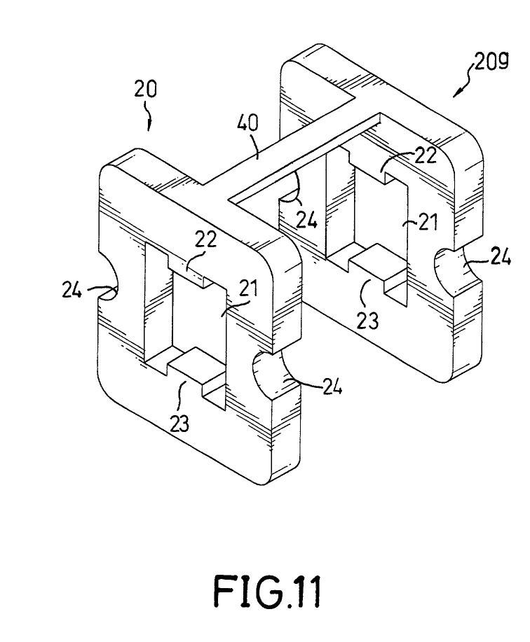

Now referring to FIG. 10, a seventh embodiment of a clamp sheet (20f) has two V-shaped concavities (241) respectively defined at two opposite sides thereof.

FIG. 11 shows an eighth practicable embodiment of the invention. Two clamp sheets (20) are combined together by a connecting bar (40) extending therebetween. The clamp sheets (20) are inserted into the corresponding slits (15) of the connector (10).

Because the clamp sheets (20x) of the connector (20) are defined with the H-shaped opening (21) having insertion pieces (22, 23) formed therein, the present invention has an advantage that the insertion pieces (22, 23) are able to pierce the outer cover (31) of the cable (30), which clamps the cable (30) tightly and prevents the cable (30) from a rotation with respect to the connector (10).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector for a fiber optic cable having a head, a waist and a holding portion, and having a stepped hole defined therein to receive the fiber optic cable fitted therein, wherein the holding portion of the connector is defined with at least one slit extending radially therethrough, a rectangular clamp sheet is fitted in the slit, wherein the improvements comprise:
the clamp sheet has two concavities respectively defined at two opposite sides thereof, and has therein defined an H-shaped opening having upper and lower edges respectively formed with two insertion pieces extending therefrom along a same extending direction of the clamp sheet; whereby
when upper and lower ends of the clamp sheet are pressed inwardly, the insertion pieces of the clamp sheet respectively pierce an outer cover of the fiber optic cable fed through the opening of the clamp sheet.

2. The connector for a fiber optic cable as claimed in claim 1, wherein the clamp sheet has two arched concavities respectively defined at opposite sides thereof.

3. The connector for a fiber optic cable as claimed in claim 1, wherein the clamp sheet has two V-shaped concavities respectively defined at opposite sides thereof.

4. The connector for a fiber optic cable as claimed in claim 1, wherein the upper end of the clamp sheet is defined with a V-groove.

5. The connector for a fiber optic cable as claimed in claim 1, wherein the lower end of the clamp sheet is defined with a V-groove.

6. The connector for a fiber optic cable as claimed in claim 1, wherein the upper and lower ends of the clamp sheet are respectively defined with two V-grooves.

7. The connector for a fiber optic cable as claimed in claim 1, wherein one of the two insertion pieces of the H-shaped opening is formed with a toothed edge.

8. The connector for a fiber optic cable as claimed in claim 1, wherein the two insertion pieces of the H-shaped opening are respectively formed with two toothed edges.

9. The connector for a fiber optic cable as claimed in claim 1, wherein at least two clamp sheets are combined together by a connecting bar secured with each clamp sheet, the at least two clamp sheets are respectively fitted into the corresponding at least two slits.
